(19) United States
(12) Patent Application Publication
(10) Pub. No.: US 2012/0272967 A1
(43) Pub. Date: Nov. 1, 2012

(54) Mask Structure and Compositions for Use in Decreasing the Transmission of Human Pathogens

(75) Inventors: Neal George Stewart, Hong Kong (HK); Melissa Mowbray-D' Arbela, Hong Kong (HK); Dacey J. Ryan, Hong Kong (HK)

(73) Assignee: Filligent Limited, Hong Kong (HK)

(21) Appl. No.: 13/410,314

(22) Filed: Mar. 2, 2012

Related U.S. Application Data
(60) Provisional application No. 61/448,209, filed on Mar. 2, 2011.
(60) Provisional application No. 61/449,077, filed on Mar. 3, 2011.
(60) Provisional application No. 61/470,517, filed on Apr. 1, 2011.

(51) Int. Cl. A62B 7/10

(52) U.S. Cl. 128/206.12

(57) ABSTRACT

A facemask structure for inactivating pathogens includes a facial contact layer that is benign to human skin followed by a subsequent interior layer and an outer layer including an anti-pathogenic material. In this manner, active, isolated anti-pathogen layers can be provided in a multilayer mask structure. For example, an important anti-viral mask structure uses one or a mixture of acids to create a low pH environment on the first inner (or outer hydrophilic layer) so that the virus laden droplets from, e.g., a sneeze, are absorbed into and away from the surface. Thus, for an infected wearer, two or more hydrophilic layers on the interior of the mask can protect the environment from an infected wearer.

### CROSS-REFERENCE TO RELATED APPLICATIONS

The present invention claims priority to U.S. Provisional Patent Application Nos. 61/448,209, 61/449,077 and 61/470,517, the disclosures of which are incorporated by reference herein.

### BACKGROUND

There are a variety of infectious human diseases, such as human respiratory tract infections, that are caused by human pathogens such as bacteria, fungi and viruses. For example, viral, bacterial, spore and fungal-induced causes of infectious human diseases (and their associated diseases) including but not limited to: Influenza A virus (including ‘swine flu’ such as the 2009 H1N1 strain); Influenza B-C virus (coryza; ‘common cold’); Human adenovirus A-C (various respiratory tract infections; pneumonia); Human Para-influenza virus (coryza; ‘common cold;’ croup); Mumps virus (epidemic parotitis); Rubeola virus (measles); Rubella virus (German measles); Human respiratory syncytial virus (RSV) (coryza; ‘common cold’); Human coronavirus (SARS virus) (SARS); Human rhinovirus A-B (coryza; ‘common cold’); parvovirus B19 (fifth disease); variola virus (smallpox); varicella-zoster virus (herpes virus) (chickenpox); Human enterovirus (coryza; ‘common cold’); Bordetella pertussis (whooping cough); Neisseria meningitidis (meningitis); Corynebacterium diphtheriae (diphtheria); Mycoplasma pneumoniae (pneumonia); Mycobacterium tuberculosis (tuberculosis); Streptococcus pyogenes/pneumoniae (strep throat, meningitis, pneumonia); Bacillus anthracis, Haemophilus influenzae Type B (epiglottis, meningitis, pneumonia), Aspergillus spp.

Many of the human respiratory tract infections result in significant morbidity and mortality. For example, seasonal epidemics of influenza viruses worldwide infect an estimated 3 million to 5 million people, and kill between 250,000 to 500,000 people each year. In addition, cyclical influenza virus pandemics occur, such as the influenza outbreak in 1918 which killed between 20 million and 50 million people worldwide.

Among the modes of transmission of these infectious human diseases are by airborne transmission of infectious particles expelled from the respiratory tract of an infected person by coughing or sneezing, or by simple exhalation, and into the gastrointestinal or respiratory systems of a previously non-infected person by inhalation. To combat this form of transmission, facial masks have been developed that either mechanically intercept the infectious particles, or that inactivate the infectious particles, or both mechanically intercept the infectious particles and inactivate the infectious particles, by a variety of mechanisms.

Protective facial masks are designed to be worn by both the infected person to prevent transmission of infection, and by the non-infected person to prevent being infected. Current facemasks designed to actively kill or inactivate pathogens have only one single active anti-pathogen layer which can be either hydrophilic or hydrophobic and consist of any compounds or materials aimed to actively kill or inactivate a range of pathogens harmful to human health, that includes viruses, bacterial, fungus, bacterial spores and fungal spores.

### DETAILED DESCRIPTION

To overcome the drawbacks of incorporating only one single active anti-pathogen layer, two or more layers, or permutations of hydrophilic and/or hydrophobic mask layers, each optionally incorporating on or more anti-viral, anti-bacterial, anti-fungal and anti-spore (anti-pathogen) substances, are incorporated into a facemask. During wear, various liquid/aerosol volumes containing pathogens will be challenged to the mask with a variety of liquid/aerosol dynamics. Liquid and aerosol challenges containing infectious pathogens will exhibit variability in total volume, velocity of challenge, droplet size of challenge, range of exposure time relative to challenge, rate of absorption into the facemask layers, and rate of draw/inhalation by the wearer. As such, one active mask layer is not sufficiently capable of maintaining anti-pathogen performance, nor inactivating a wide spectrum of infectious pathogens over both a sufficiently short period of time, as well as an extended period of time. An increased spectrum of pathogen inactivation and persistent anti-pathogen activity will be exhibited with the inclusion of one or more additional inner active anti-pathogen layers, with each active agent having a different mechanism by which pathogens are inactivated.

In an exemplary embodiment, one or more outer layers is hydrophilic and optionally includes an anti-pathogenic material. In the case of the pathogen-laden load breaching the outer active layer due to velocity or volume load, either with or without draw (inhalation), the pathogen load may be rapidly absorbed into and away from the surface of the outer layer with which the wearer may make contact, and into the inner active anti-pathogen layers of the mask where the load can be isolated within the structure of the mask and further inactivated over an extended period of time. A variety of hydrophilic outer layers can be selected; in the case of a large liquid challenge, for example, a mask design may have an outer active layer of a polypropylene-based material coated with a hydrophilic polymeric material creating a mask layer that can rapidly absorb liquid away from the surface of and into the outer active layer. Liquid can then rapidly be transferred into and held within an inner active layer, such as a naturally hydrophilic cellulose/polyester layer optionally including anti-pathogenic material. Examples of hydrophilic materials (including polymer-treated polypropylene) and anti-pathogenic materials to be incorporated into the layers are disclosed in U.S. provisional application 61/298,194, PCT application PCT/US09/45621, WO 2010/138426, U.S. provisional application 61/180,085, WO 2009/158527, the disclosures of which are incorporated by reference herein.

The present invention also provides a composition for coating polymeric material, and materials including polymeric material, such as for example a fabric or a material for use in decreasing the transmission of the human pathogens. The polymeric material can be but not limited to cellulosic, polyolefin, polyamide, polyethylene terephthalate, polyamide, vinyon or their blends (including blends with natural fibers). Other materials, including cellulose-based materials, can also be treated with the compositions of the present invention. In one embodiment, the composition comprises an aqueous solution of water soluble or water dispersible polymer, one or more than one organic acid, salts of organic acid, derivatives of organic acid, fatty acid, monoglycerides of fatty acid, esters of fatty acid, anionic surfactant and amphoteric surfactant. In another embodiment, the composition may contain crosslinking agent and catalyst. In another embodiment, the composition further comprises one or more than one type of bactericidal, fungicidal or viricidal agent.

In one embodiment, the water soluble polymer is selected from vinyl polymer with structure as shown in formula (1).

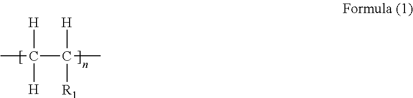

or
where R₁ is: —NH₂.HCl

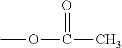

or

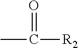

or

—OR₃ or

—CR₄

where R₂ is: —O

—NH₂

—CH₃

—ONa

where R₃ is: —H

—CH₃

where R₄ is: —H₂NH₂

—H₂NH₂xHCl

—H₃

In another embodiment, the water soluble polymer is glucose polymer with structure as shown in formula (2).

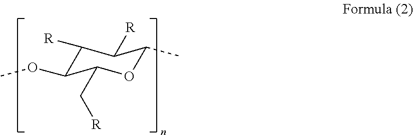

### Where R=OH, OCH₂CH₃, OCH₂CH₂COOH, NH₂

In another embodiment, the water soluble polymer is polyether with structure as shown in formula (3).

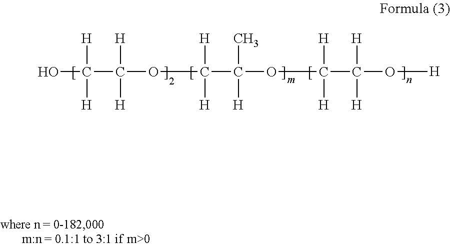

In another embodiment, the water soluble polymer is polyamine with chemical formula (4).

(C₂H₅N)ₙ.X Formula (4)
where X is (C₂H₅N) or (C₂H₈N₂)ₘ or (C₄H₁₀N₂)ₘ,

In one embodiment, the organic and fatty acid is selecting from acetic acid, adipic acid, arachidonic acid, ascorbic acid, benzene-carboxylic acid, benzoic acid, butylic acid, capric acid, caproic acid, caprylic acid, cinnamic acid, citric acid, dodecenoic acid, elaidic acid, erucic acid, formic acid, fumaric acid, gallic acid, gluconic acid, glutaric acid, lactic acid, lauric acid, linolenic acid, 1-pyroglutamic acid, maleic acid, myristic acid, myristoleic acid, oleanolic acid, oleic acid, palmitic acid, palmitoleic acid, pelargonic acid, peracetic acid, propionic acid, pyruvic acid, salicylic acid, sorbic acid, stearic acid, succinic acid, tartaric acid, tridecenoic acid, undecenoic acid, ursolic acid or usnic acid.

In one embodiment, the salts of acid is selecting from calcium lactate, calcium propionate, potassium sorbate, sodium acetate, sodium alginate, sodium chloride, sodium citrate, sodium dehydroacetate, sodium diacetate, sodium lactate, sodium nitrite, sodium oleate, sodium propionate, sodium pyruvate, sodium ricinoleate or trisodium citrate.

In one embodiment, the monoglycerides and ester of fatty acid is selecting from polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, monocaprylin, monocaprin, monolaurin, monomyristin, monopalmitin, monostearin, monoolein, glycerol monolaurate, glycerol monocaprate, glycerol monocaprylate, undecenoyl monoglyceride, dodecanoyl monoglyceride and tridecanoyl monoglyceride, methyl linoleate and methyl linolenate.

In one embodiment, the anionic surfactant is selecting from dodecylbenzene sulfonic acid, sodium dodecylbenzene sulfonate, sodium dioctylsulfosuccinate, sodium lauryl sulfate, sodium salt of sulfonated oleic acid, sodium 1-octane sulfonate, sulfonated 9-octadecenoic acid, sodium xylene sulfonate, dodecyldiphenyloxide disulfonic acid, sulfonated tall oil fatty acid, sodium salt of naphthalene-sulfonic acid and 1-octane sulfonic acid.

In one embodiment, the amphoteric surfactant is selecting from dodecylglycine, dodecylaminoethylglycine and dodecyldiaminoethylglycine.

In another embodiment, the composition further comprises one or more than one type of bactericidal, fungicidal or viricidal agent, which can be but not limited to multivalent metal salts, quaternary ammonium compounds, antibiotics, farnesol, eugenol or triclosan.

In one embodiment, the metal salt is a copper salt selecting from copper acetate, copper dithionate, copper fluorosilicate, copper formate, copper gluconate, copper glycerophosphate, copper halides, copper iodide, copper lactate, copper nitrate, copper phenolsulfonate, copper salicylate, copper stearate, copper succinate, copper sulfate, copper tartrate. In another embodiment, the metal salt is a zinc salt selecting from zinc acetate, zinc ammonium sulfate, zinc chromate, zinc citrate, zinc formate, zinc gluconate, zinc glycerophosphate, zinc halides, zinc iodide, zinc lactate, zinc nitrate, zinc phenolsulfonate, zinc salicylate, zinc stearate, zinc succinate, zinc sulfate, zinc tartrate.

In one embodiment, the quaternary ammonium compounds can be but not limited to benzalkonium chloride, benzethonium chloride, cetylpyridinium chloride, cetyltrimethylammonium bromide, dedecylbenzyldimethyl-ammonium chloride, didecyldimethylammonium chloride, dioctyldimethylammonium chloride, ditetradecyldimethyl-ammonium chloride, dodecyltrimethylammonium chloride, hexadecyltrimethyl-ammonium chloride, tetradeocyltrimethyl-ammonium chloride, tri(octyldecyl)methyl-ammonium chloride, tridodecylmethyl-ammonium chloride.

In one embodiment, the antibiotics is selecting from ancovenin, duramycin, epidermin, naphazoline, nisin and tetracaine.

The products that can include the above compositions can include one of the above compositions or a combination of more than one of the above compositions. The products may include layers of substrate material treated with one or more of the above materials such that a multilayer product is formed each layer of which includes one or more bactericidal, fungicidal or viricidal agent as set forth above. Examples of methods for treating materials with the above compositions include coating by spraying, immersion, contact coating (e.g., roller coating) or any other technique that can provide the above material compositions to a substrate. Further details of coating techniques and exemplary active material percentages are found in U.S. provisional application 61/298,194, PCT application PCT/US09/45621, WO 2010/138426, U.S. provisional application 61/180,085, WO 2009/158527, the disclosures of which are incorporated by reference herein. The materials described above can be applied to the facemasks and other products described in these patent applications.

The materials of the present invention find application in a wide variety of items for which it is desired to impart bactericidal, fungicidal or viricidal properties. Applications cover any product areas aimed at any anti-viral, anti-bacterial, anti-microbial, anti-fungal, anti-spore features such as those applications to protect and enhance infection control and human health. Applications include but are not limited to masks, respirators, air filters, water filters and water treatment, shoe insoles, natural and synthetic materials and textiles—such as wipes, dots, drapes and gowns, diapers, curtains, bed linen, clothes, wash-cloths, and cellulosic materials such as paper, tissues, napkins.

The present invention is also applicable also to polymers and plastics such as computer keyboards, plastic enclosures, computer mouses, cell phones, push-buttons, escalator side runners/hand-contacting belts, floors, walls, and any building materials.

The compositions further find use in polymers and plastics used in domestic environments such as kitchens—utensils, cups, glasses, chopping boards, and also children's products environment such as toys.

The present compositions can also be used in cosmetics and skin management applications such as creams, puffs, wipes, sponges, sticks, and also wound care products such as dressings, bandage, and hair and scalp care, and contact lenses.

Medical applications include gloves, catheters, wound drains, drapes, gowns, curtains, and bed linens.

Foot health applications include insoles that are anti-odor, anti-microbial, anti-fungal, e.g. anti-athletes foot, also to suppress diabetes pathogens, and also can be added directly into shoes and foot wear products.

There are a variety of infectious human diseases, such as human respiratory tract infections, that are caused by human pathogens such as bacteria, fungi and viruses. For example, viral, bacterial, spore and fungal-induced causes of infectious human diseases (and their associated diseases) including but not limited to: Influenza A virus (including ‘swine flu’ such as the 2009 H1N1 strain); Influenza B-C virus (coryza; ‘common cold’); Human adenovirus A-C (various respiratory tract infections; pneumonia); Human Para-influenza virus (coryza; ‘common cold;’ croup); Mumps virus (epidemic parotitis); Rubeola virus (measles); Rubella virus (German measles); Human respiratory syncytial virus (RSV) (coryza; ‘common cold’); Human coronavirus (SARS virus) (SARS); Human rhinovirus A-B (coryza; ‘common cold’); parvovirus B19 (fifth disease); variola virus (smallpox); varicella-zoster virus (herpes virus) (chickenpox); Human enterovirus (coryza; ‘common cold’); Bordetella pertussis (whooping cough); Neisseria meningitidis (meningitis); Corynebacterium diphtheriae (diphtheria); Mycoplasma pneumoniae (pneumonia); Mycobacterium tuberculosis (tuberculosis); Streptococcus pyogenes/pneumoniae (strep throat, meningitis, pneumonia); Bacillus anthracis, Haemophilus influenzae Type B (epiglottis, meningitis, pneumonia), Aspergillus spp.

Many of the human respiratory tract infections result in significant morbidity and mortality. For example, seasonal epidemics of influenza viruses worldwide infect an estimated 3 million to 5 million people, and kill between 250,000 to 500,000 people each year. In addition, cyclical influenza virus pandemics occur, such as the influenza outbreak in 1918 which killed between 20 million and 50 million people worldwide.

Among the modes of transmission of these infectious human diseases are by airborne transmission of infectious particles expelled from the respiratory tract of an infected person by coughing or sneezing into the environment, or by simple exhalation, and into the gastrointestinal or respiratory systems of a previously non-infected person by inhalation. To combat this form of transmission, facial masks have been developed that either mechanically intercept the infectious particles, or that inactivate the infectious particles, or both mechanically intercept the infectious particles and inactivate the infectious particles, by a variety of mechanisms.

Protective facial masks are designed to be worn by both the infected person to prevent transmission of infection, and by the non-infected person to prevent being infected. Current facemasks designed to actively kill or inactivate pathogens have only either one single active anti-pathogen layer which are hydrophobic and consist of any compounds or materials aimed to actively kill or inactivate a range of pathogens harmful to human health, that includes viruses, bacterial, fungus, bacterial spores and fungal spores.

To overcome the drawbacks of incorporating only one or more active hydrophobic anti-pathogen layers, two or more layers, or permutations of hydrophilic mask layers, each optionally incorporating one or more anti-viral, anti-bacterial, anti-fungal and anti-spore (anti-pathogen) substances, are incorporated into a facemask. During wear, various liquid/aerosol volumes containing pathogens will be challenged to the mask with a variety of liquid/aerosol dynamics either from the infected environment to the outside of the mask, or from an infected wearer towards the outside environment via the layer of the mask adjacent the face of the wearer. Liquid and aerosol challenges containing infectious pathogens will exhibit variability in total volume, velocity of challenge, droplet size of challenge, range of exposure time relative to challenge, rate of absorption into the facemask layers, and rate of draw/inhalation by the wearer. As such, one active mask layer is typically not sufficiently capable of maintaining anti-pathogen performance, nor inactivating a wide spectrum of infectious pathogens over both a sufficiently short period of time, as well as an extended period of time. An increased spectrum of pathogen inactivation and persistent anti-pathogen activity will be exhibited with the inclusion of one or more additional inner hydrophilic active anti-pathogen layers as an internal mask layer, with each active agent having a different mechanism by which pathogens are inactivated.

Examples of hydrophilic materials (including polymer-treated polypropylene) and anti-pathogenic materials to be incorporated into the layers are disclosed in U.S. provisional application 61/298,194, PCT application PCT/US09/45621, WO 2010/138426, U.S. provisional application 61/180,085, WO 2009/158527, the disclosures of which are incorporated by reference herein.

Because internal active anti-pathogen hydrophilic layers are isolated physically within the internal mask structure and thus are not in contact with the skin of the wearer, the layers do not have any potential negative impact on the wearer such as skin reactions or irritation. Hence these inner layers have far greater flexibility regarding the selection and concentration of a compound or mixture of anti-pathogenic compounds that can be used to enhance mask pathogen killing or inactivation efficacy, without the concern or possibility of any skin contact.

In an exemplary embodiment a first interior layer (or, optionally, an exterior layer either adjacent to the face or furthest from the wearer that may be in contact with the skin, or handled by the mask wearer), is designed to be more benign to human skin than the next interior layer or first interior layer when an anti-pathogen material is in an exterior layer. In this manner, active, isolated anti-pathogen layers can be provided in a multilayer mask structure. For example, an important anti-viral mask structure uses one or a mixture of acids to create a low pH environment on the first inner (or outer hydrophilic layer) so that the virus laden droplets from, e.g., a sneeze, are absorbed into and away from the surface. The droplets are also opened by the first hydrophilic inner or outer layer and, as the droplets are opened, they are absorbed into and away from the surface in the first inner or outer layer. The viruses in the droplets are then exposed to a specifically designed low pH environment that inactivates the virus and are drawn away from the surface and into the first outer or inner hydrophilic layer, and in the case of a higher level of droplet challenge, the additional hydrophilic multi-layers continue to absorb into and away from the inner mask surface or the outer mask surface (depending on the direction of airflow-inhalation or exhalation). Thus, for an infected wearer, two or more hydrophilic layers on the interior of the mask can protect the environment from an infected wearer, that is any infected aerosol droplets from the respiratory tract of the infected wearer are not only opened on contact with a first inner hydrophilic layer, but are also rapidly absorbed into and away from the surface of the first inner layer, and in the case of a high droplet velocity, or high velocity challenge, the second or any additional hydrophilic layers continue absorbing and drawing the aerosol challenge into the hydrophilic interior layers and away from the outer layer contacting the wearer's face.

For an exterior layer that is in contact with the skin of the wearer, the pH level is specifically limited to a minimum level, for example, pH 4. Since many viruses are inactivated in low pH environments (e.g., less than a pH of 5), virus inactivation will take place even at a pH of 4. It is generally accepted in the industry that the benign range of pH for material in contact with the skin is a pH of from 4 to 8, although a pH of 3 can be considered safe. However, to increase the efficacy of virus inactivation a much lower pH is desired. Therefore, interior layers that are not in contact with the skin can use a much lower pH, for example, a pH of from 1.5 to 2.0. As a result, a multilayer structure is created with a decreased pH in one or more interior layers that are not in contact with the skin (either against the face or on the exterior layer furthest away from the face that will contact skin such as the hands of the wearer). This decreased pH can be obtained by using the same acid or mixture of acids having a different concentration as optionally used in the skin-contacting exterior layers. Alternatively, the lower pH can be obtained from a different acid or mixture of acids as used for the higher pH layer(s). In this manner the overall mask efficacy and anti-viral performance is increased while maintaining a safe pH level on exterior skin-contacting layers.

In a further exemplary embodiment, an outer hydrophilic layer having a low pH (but benign to the human skin) such as a pH of 3 for enhanced virus inactivation is provided. In this mask structure, the inner layer or layers can not only have a much lower pH (e.g., a pH of less than 2) but also include other anti-pathogen materials, for example multivalent metal compounds of copper, zinc, or silver, such as salts of these metals. These can be used individually or in combination including further materials that impart additional anti-viral and/or anti-bacterial and/or, anti-fungal properties. Since these anti-pathogen compounds are placed in internal layers within the mask that are away from any potential contact with the wearer's skin, there is increased flexibility in the choice anti-pathogenic materials for these inner layers; further the pathogens are trapped within the interior of the physical mask structure within one or more of these inner layers isolated within the mask structure. Consequently, the time it takes for the selected interior layer anti-pathogenic materials to inactivate or kill any pathogens can be longer than the anti-pathogenic materials in the outer layer, since the interior layers are isolated from human contact.

When protecting a mask-wearer from an infected environment, one or more outer layers (such as the exterior layer furthest from the wearer's face) are hydrophilic and optionally include an anti-pathogenic material. In the case of the pathogen-laden load breaching an exterior active layer due to velocity or volume load, either with or without draw (inhalation), the pathogen load may be rapidly absorbed into and away from the surface of the exterior layer with which the wearer may make contact (e.g., with the wearer's hands), and into one or more active interior anti-pathogen layers of the mask where the load can be isolated within the structure of the mask and further inactivated over an extended period of time. A variety of hydrophilic exterior layers can be selected; in the case of a large liquid challenge, for example, a mask design may have an exterior active layer of a polypropylene-based material coated with a hydrophilic polymeric material creating a mask layer that can rapidly absorb liquid away from the surface of and into the exterior active layer. Liquid can then rapidly be transferred into and held within an interior active layer, such as a naturally hydrophilic cellulose/polyester layer optionally including anti-pathogenic material, as described above.

In another exemplary embodiment for the case of protecting a mask-wearer from an infected environment, one or more interior layers are hydrophilic and optionally include an anti-pathogenic material. In the case of the pathogen-laden load breaching the first interior active layer due to velocity or volume load, either with or without draw (inhalation), the pathogen load may be rapidly absorbed into and away from the surface of an exterior layer, and into the next inner active anti-pathogen layers of the mask where the load can be isolated within the structure of the mask and further inactivated over an extended period of time. A variety of hydrophilic inner layers can be selected; in the case of a large liquid challenge, for example, a mask design may have an exterior layer of a polypropylene-based material coated with a hydrophilic polymeric material creating a mask layer that can rapidly absorb liquid inhaled by the wearer or otherwise penetrating the mask and transferring it to an interior active layer. Liquid can then rapidly be transferred into and held within interior hydrophilic active layers, such as a naturally hydrophilic cellulose/polyester layer optionally including anti-pathogenic material.

In the case of a mask configured to protect both the wearer from an infected environment, and the environment from an infected wearer, the mask design can consist of one or more hydrophilic exterior layers (adjacent the face and farthest away from the face), and also one or more anti-pathogenic inner layers between the exterior layers.

1. A facemask structure for inactivating pathogens comprising:
a facial contact inner layer that is benign to human skin;
a subsequent interior layer;
a hydrophilic outer layer including an anti-pathogenic material, the mask including one or a mixture of acids to create a low pH environment in either the facial contact inner layer or outer hydrophilic layer so that the virus laden water droplets are absorbed into and away from the mask surface.
